(19) United States
(12) Patent Application Publication
(10) Pub. No.: US 2011/0223228 A1
(43) Pub. Date: Sep. 15, 2011

(54) Repellant for Ground Rooting Animals

(76) Inventors: Eric Pipkin, Sparta, WI (US); Charlie Hicks, Daytona Beach, FL (US)

(21) Appl. No.: 12/884,007

(22) Filed: Sep. 16, 2010

Related U.S. Application Data
(60) Provisional application No. 61/242,976, filed on Sep. 16, 2009.

(51) Int. Cl. A01N 25/26; A01N 65/38; A01N 25/08; A01P 17/00

(52) U.S. Cl. 424/417; 424/760; 424/409

(57) ABSTRACT

A repellant composition for ground rooting animals is disclosed that includes a limestone carrier of capsicum powder and a limestone sorbent for castor oil that each has a limestone coating bound to them by a binding agent. The limestone sorbent is porous and provides a long-sustained release of repellant elements from the composition, while providing a composition that is dry to the touch. The repellant composition is spread on the ground, drenched to work it into the ground and then allowed to dry. The composition maintains effectiveness for several months while being beneficial to soil.

The present invention claims benefit of U.S. provisional patent application no. 61/242,976 filed on Sep. 16, 2009.

### FIELD OF THE INVENTION

The present invention relates to compositions for repelling ground rooting animals, a method of repelling ground rooting animals and a method of manufacture of a repellant for ground rooting animals.

### BACKGROUND

Various types of repellant compositions are well known in the art, and several methods for introducing such repellants into a control environment are also known. Some repellants that might work for ground rooting animals are not acceptable for ecological reasons and others are not effective or long-lasting. Other compositions and methods have been devised that are appropriate for repelling birds, rodents or other pests besides ground rooting animals, but such compositions or methods are not proven to work effectively and long-lasting for ground rooting animals such as armadillos.

For example, U.S. Pat. No. 5,674,496 teaches the use of an extract to treat a fixed object and protect that object, such as wires, cables, containers and the like. It was well know that pests have a natural aversion to capsaicinoids including capsaicin. U.S. '496 took advantage of this natural aversion by using capsaicinoids as a repellant additive in polymeric coatings. The additive is produced by adding capsicum to a liquid solvent to extract capsaicinoid essential oils, i.e. natural repellant. The extract is applied to a surface of an object by soaking the covering material in the extract, adding the extract to an insulation product, or adding the extract to paint, rubber, plastics, glues, sealants, etc.

U.S. Pat. No. 6,159,474 offers an animal repellant composition suitable for use by deposition onto the ground. The repellant contains capsicum oils with oil as a carrier and lard used to bind the substances. Other substances included are oleoresin of capsicum and an antioxidant for stabilizing. These substances are combined onto an inert solid material that is finely divided. The composition as manufactured and composed is effective for a number of larger species of animals such as dogs, cats, raccoons, skunks, mice, rats, squirrels, etc. However, the composition is not particularly suited to long-lasting effectiveness for repelling ground rooting animals such as armadillos. Additionally, the composition of U.S. '474 is most effective in humid and damp environments and, after only three or four days in a dry environment, the action of the composition appears to be less effective.

U.S. Pub. No. 2006/0257443 provides a pest control composition and method using cellulosic fibrous material and a mineral sorbent material, such as bentonite clay, as a carrier to form particles of a carrier and a pest repellant. The publication recognizes the need for a sorbent that allows sustained release of at least some of the control agent into an environment without feeling oily to the touch. While it is observed that the foregoing compositions are suitable for use in repelling many pests, still further modifications and improvements are needed for repelling especially persistent ground rooting animals, particularly the armadillo, and even more particularly the nine-banded armadillo (Dasypus novemcinctus), which is most common in the central southernmost states, particularly Texas.

Armadillos feed on roots, earth worms, ants, grubs, beetles and all kinds of insects. As a result, armadillos are equipped with sensitive olfactory bulbs that detect odor, and the armadillo uses the nose for foraging in the ground. A major part of an armadillo's food source is found under the surface of the soil. An armadillo can identify and root up a grub as deep as six (6) inches beneath the surface of soil. The digging and scratching of the armadillo into the soil with the front paws to retrieve such food causes significant damage and mars lawns and garden plants, often times leaving behind a number of cone-shaped holes three to six inches deep. In addition to the digging and destruction, armadillo build burrows and populations increase rapidly. As a result armadillos often cause damage by burrowing under houses, air conditioning units, or plants and shrubs, causing still further damage. Further nuisance can be created by the animals that inherit these burrows, such as rates, tortoises and snakes. Finally, armadillos carry disease that can infect humans. Therefore, it is highly desirable to remove armadillos from yards and other areas frequently occupied by humans. Fortunately, armadillos have sensitive taste and smell that can be used against them to create a positive punishment that will condition them to leave an area. However, the persistent problem has been providing a long-lasting conditioning agent that can be used specifically for ground rooting animals. This invention seeks to utilize the armadillo's senses to change the behavior of the animal through operant conditioning.

The present invention seeks to provide a repellant composition and method for ground rooting and digging animals that, in preferred embodiments, is distributed as pellets as an all natural product that is an effective repellant, while beneficial to soil. The invention seeks to provide a composition that can be distributed into soil and conditions the soil through drenching and then drying for sustained release of oils. In the preferred embodiments, the composition becomes even more effective as ground rooting animals attempt to root and disturb soil, further conditioning the soil with the repellant properties of the composition.

### SUMMARY OF THE INVENTION

The present invention has found that a repellant composition may be prepared using capsaicinoids and limestone. In accordance with the invention capsicum powder and castor oil are used as repellant substances, and are combined using limestone with binding agents. In a highly preferred embodiment, the limestone comprises several components incorporated through a process of manufacture including a limestone carrier pellet, a limestone absorbent of specific grade, and a limestone coating. In this highly preferred embodiment, the limestone absorbent comprises grade L10×60, referred to in the trade as Florida Limestone, known to be mined in the region of Ocala, Florida in the United States.

Preferably, the product is manufactured into the preferred form of pellets that are dry to the touch and easily broadcast onto the ground in an effected area. In the preferred method, the pellets are then watered into the ground and let to dry. Over time, the oils with capsicum are released from the absorbent limestone into the surrounding soil. The product become more effective after several days as the composition becomes more thoroughly distributed into the soil and is even enhanced by any interim rooting and digging by ground rooting animals, while the limestone provides benefits for the soil.

Thus, an object of the present invention is to provide a long-lasting repellant for ground rooting and digging animals that protects lawns and gardens from destruction by these pests.

Another object of the invention is to provide a repellant that is all natural and not harmful to animals or humans.

Still another object of the invention is to provide a repellant that is also beneficial to the soil.

Another object is to provide a repellant that is effective even in dry soil for repelling ground rooting animals.

Yet another object of the invention is to provide a repellant for ground rooting animals that may be applied broadly and quickly in a lawn or garden area.

### DETAILED DESCRIPTION OF THE PREFERRED EMBODIMENTS

In a first preferred aspect of the invention, a composition is provided for repelling ground rooting animals from a lawn or garden, and the composition includes limestone as a carrier pellet, an absorbent, and a coating. In the preferred embodiment, the limestone carrier pellet is limestone of grade L7×14 [CaCO₃ Grade L7×14], the limestone for oil absorption is limestone of grade L10×60 [CaCO₃ Grade L10×60], and the limestone for coating is limestone of grade L90×200 powder [CaCO₃ Grade L90×200]. It is contemplated that the exact grades of limestone may be varied somewhat according to costs and quality considerations, particularly with respect to the carrier pellet and the coating agent. However, the limestone for oil absorption has been found highly effective for long-lasting release while providing a dry touch. Therefore, the Florida limestone grade L10×60 mined near Ocala, Florida USA is presently preferred, as it provides absorption of up to 7% by weight of oil into the limestone while still providing a dry feel. Other grades of limestone are less effective and produce an inferior product.

The composition includes capsicum ground powder (C₁₈H₂₇NO₃) as a repelling substance that is bound to the limestone carrier pellets by a binding agent such as a lignosulfonate. The composition further includes castor oil, preferably 100% industrial grade, as a repelling substance and release agent that is absorbed by the oil absorbent limestone grade L10×60. A surfactant such as liquid dish detergent combined with water is used to improve the distribution of the castor oil and absorption by the limestone.

In a method of formulating the composition, the formulation includes a binding agent, a product A, a product B, and a product C, which incorporates product B therein. Products A and C are combined in equal parts to form the finished product for packaging, typically into 40 pound bags or buckets.

The formulation is outlined as follows:

Binding Agent (B/A):

Ligno Concentrate Solution: Lignosulfonate (Norlig A exemplary)+Distilled H₂O

Ligno Working Solution: Ligno Concentrate Solution+Distilled H₂O

Product A:

Limestone Granules—[CaCO3 Grade L7×14]+B/A+[C18H27NO3]+B/A+Limestone Powder [CaCO3, Grade L90×200]+B/A+Limestone Powder [CaCO3, Grade L90×200]

Product B:

Castor Oil (CO)+Liquid Dish Detergent (LDD)+H₂O

Product C:

Limestone Granules [CaCO3 Grade L10×60]+[Product B][@Ratio of 1::0.1 by weight, Limestone to Product B]+B/A+CaCO3 (L90×200)+B/A+CaCO3 (L90×200)

Finished Product:

Equal parts of: Product A and Product C.

The composition and formulation is manufactured in accordance with the following method, while being adjusted for quantity and quality.

First, a binding agent working solution is prepared, referred to as B/A. Product A is then prepared by mixing a limestone carrier with the B/A and then adding the capsicum onto granules of the limestone carrier that is wet with the B/A. After mixing well and adding the capsicum, the B/A is again used to wet the limestone capsicum combination, and then a limestone coating is added and mixed to coat the carrier until dry. The B/A and limestone coating may be added again in an additional step for thorough coating of the limestone carrier and capsicum combination. The substances are mixed again until dry.

Product B is prepared separately from Product A by mixing industrial grade castor oil with a suitable detergent or surfactant agent such liquid dish. Both the oil and detergent are mixed with water and transferred into a distribution device such as a sprayer for further use in creation of Product C.

Product C is prepared by mixing a limestone absorbent with Product B to absorb Product B up to 7% by weight with the limestone absorbent. The limestone and Product B are mixed until dry and then binding agent (B/A) is added to wet the exterior surface of the mixture. A limestone coating is added and mixed to coat the carrier until dry. As with Product A, the B/A and limestone coating may be added again in an additional step for thorough coating of the limestone absorbent and oil combination. The substances are mixed again until dry. The final product is produced by combining and mixing Product A and Product C, then packaging the combination.

Following is an exemplary manufacturing example using the method provided above:

### Example

Binding Agent (B/A) or Working Solution:

| | | |
|---|---|---|
| Lignosulfonate (Norlig A) | 100 | pounds |
| Distilled H₂O | 7.5 | Gallons |

a) Mix 100 pounds Lignosulfonate Norlig A powder into 7.5 Gallons H₂O. Stir and mix constantly until the powder appears to be in solution. (Mixing may use a mixing paddle attached to an electric drill.)

b) Let this Ligno Solution sit for 24 hours to ensure that all of the Lignosulfonate powder is dissolved into solution.

c) This is the Ligno Concentrate Solution.

d) After 24 hours, mix the Ligno Concentrate Solution well before diluting to make the Ligno Working Solution.

e) After mixing the Ligno Concentrate Solution well, mix 3 parts Ligno Concentrate Solution to 1 part distilled water for a 42% Ligno Working Solution.

f) The Ligno Working Solution is referred to as binding agent or “B/A”.

Product A:

| | | |
|---|---|---|
| Limestone Granules CaCO3 (L7 × 14) | 100 | Pounds |
| Binding Agent (B/A): Working Solution | 20 | Second Spray |
| Capsicum Ground Powder [C₁₈H₂₇NO₃] | 9 | Ounces |
| Limestone-Grade L90 × 200 Powder | 2 | Pounds |

a) Place Limestone Granules (CaCO3 Grade L7×14) in mixer and start rotating (Mixing Cycle).

b) Spray Ligno Binding Agent (B/A) WorkingSolution onto the tumbling limestone granules for 5-10 seconds or until limestone granules are wet glistening brown in color.

c) Visually inspect that all limestone granules are wet with Ligno Working Solution.

d) While the mixer is tumbling the limestone granules, sprinkle Capsicum Ground Powder onto the wet granules.

e) Allow the mixer to tumble the limestone granules for 2 minutes.

f) Spray Ligno Binding Agent (B/A) WorkingSolution onto the tumbling limestone granules for 5 seconds.

g) While the mixer is tumbling the limestone granules, sprinkle in one (1) pound of limestone grade L90×200 powder.

h) Allow the mixer to tumble the limestone granules for 2 minutes.

i) Stop the mixer and inspect by visual inspection and tactile inspection to measure dryness to sight and to touch. If the limestone granules are still damp, start the mixer and add additional limestone grade L90×200 powder, one cup at a time, until the limestone granules are dry.

j) Spray Ligno Binding Agent (B/A) Working Solution onto the tumbling limestone granules for 5 seconds.

k) While the mixer is tumbling the limestone granules, sprinkle in one (1) pound of limestone grade L90×200 powder.

l) Allow the mixer to tumble the limestone granules for 2 minutes.

m) Inspect to ensure the limestone granules are dry to the touch.

Product B:

| | | |
|---|---|---|
| Castor Oil, 100% industrial grade | ½ | Gallon |
| Liquid Dish Detergent | 6 | Ounces |
| Distilled H₂O | ½ | Gallon |

a) Add 1/2 gallon Castor Oil into one (1) gallon container.

b) Add six (6) ounces Liquid Dish Washing Detergent.

c) Fill the container to the one (1) gallon mark with distilled H₂O.

d) Mix the contents of the container well by inverting.

e) Transfer the entire content of the container into a sprayer.

Product C:

| | | |
|---|---|---|
| Limestone Granules [CaCO₃ L10 × 60] | 100 | Pounds |
| Product B | 1 | Gallon |
| Binding Agent (B/A): Working Solution | 5 | Second Spray |
| Limestone-Grade L90 × 200 Powder | 1 | Pound |

a) Place the limestone granules (CaCO₃ Grade L10×60) in the mixer and start rotating (Mixing Cycle).

b) Spray one gallon of Product B while the mixer is tumbling the limestone granules.

c) Stop the mixer and inspect visually and tactilely to measure dryness. If the limestone granules are wet, add additional limestone granules grade L10×60 one cup at a time until the limestone granules feel dry.

d) Spray the Ligno Binding Agent (B/A) Working Solution onto the tumbling limestone granules for 5-10 seconds.

e) While the mixer is tumbling the limestone granules, sprinkle in one (1) pound of limestone grade L90×200 powder.

f) Spray the Ligno Binding Agent (B/A) Working Solution onto the tumbling limestone granules for 5 seconds.

g) While the mixer is tumbling the limestone granules, sprinkle in one (1) pound of limestone grade L90×200 powder.

h) Allow the mixer to tumble the limestone granules for 2 minutes.

i) Stop the mixer and inspect visually and tactilely to ensure the limestone granules are dry to sight and to the touch.

Finished Product:

| | |
|---|---|
| Product A | 100 Pounds |
| Product C | 100 Pounds |

a) Place 100 pounds of Product A into the mixer.

b) Place 100 pounds of Product B into the mixer.

c) Start the mixer and tumble the limestone granules for 5 minutes.

d) Package finished product into five 40 pound bags or buckets.

The process provided in the exemplary embodiment produces a repellant composition in accordance with discussion above. The method for repelling ground rooting animals using the composition includes the steps of providing said repellant composition in bulk for broadcast distribution on a lawn or garden. Said composition comprising limestone grade L7×14 as a carrier pellet, limestone grade L10×60 as an absorbent pellet, and limestone grade L90×200 as a coating for both limestone pellets. The carrier pellets and absorbent pellets are combined in the composition. The process provides capsicum ground powder bound to the carrier pellet and coated by limestone coating bound thereto. Further, the process also provides castor oil absorbed for slow release by the absorbent pellets and coated by the limestone coating bound thereto. The repellant composition is broadcast onto a lawn using a spreading device or by hand. After spreading, the repellant composition is drenched to water-in the repellant composition into the soil. The repellant composition is then allowed to dry. The castor oil of the repellant composition slowly releases the repellant properties of the repellant composition by leaching the castor oil into the soil. The release of the repellant properties can be further enhanced by disturbing the soil. Thus, any activity by ground rooting animals in the treated area makes the repellant composition even more effective. After several days, the repellant composition has sufficiently leaching castor oil with the repellant properties and ground rooting animals will abandon the area because of the positive punishment provided by the substance.

Preferred embodiments of the invention are discussed herein with surprisingly long-lasting and sustained results in repelling ground rooting animals such as the armadillo. Variations of the best mode discussed and preferred embodiments may become apparent to those of ordinary skill in the art. Accordingly, this invention includes all modifications and equivalents of the subject matter recited in the claims. Moreover, any combination of the above-described elements in all possible variations is encompassed by the invention claimed.

We claim:

1. A composition for repelling ground rooting animals comprising a limestone carrier, a limestone absorbent, a limestone coating, capsicum powder bound to the limestone carrier and oil that is absorbed by the limestone absorbent.

2. A composition for repelling ground rooting animals as in claim 1 in which said limestone carrier comprises limestone grade L7×14, said limestone absorbent comprises limestone grade L10×60, and said limestone coating comprises limestone grade L90×200.

3. A composition for repelling ground rooting animals as in claim 1 in which said limestone absorbent consists of limestone grade L10×60.

4. A composition for repelling ground rooting animals as in claim 1 in which said oil comprises castor oil.

5. A composition for repelling ground rooting animals as in claim 1 in which said oil comprises 7 percent by weight of limestone absorbent.

6. A composition for repelling ground rooting animals comprising a mixture of a first product and a second product, said first product including limestone carrier granules, capsicum power bound to the limestone carrier granules, and a limestone powder coating, and said second product including limestone absorbent granules, an oil absorbed by the limestone absorbent granules, and a limestone powder coating.

7. A composition for repelling ground rooting animals as in claim 6 in which said first product comprises 100 pounds of limestone carrier granules to 9 ounces of capsicum powder to 2 pounds of limestone powder coating, and said second product comprises 100 pounds of limestone absorbent granules to 1/2 gallon of oil absorbed thereby to 1 pound of limestone power coating.

8. A composition for repelling ground rooting animals as in claim 6 in which said first product and said second product are mixed in equal parts.

9. A composition for repelling ground rooting animals as in claim 6 in which said limestone absorbent granules comprise limestone grade L10×60.

10. A composition for repelling ground rooting animals as in claim 7 in which said limestone absorbent granules comprise limestone grade L10×60.
